(19) United States
(12) Patent Application Publication
(10) Pub. No.: US 2020/0097995 A1
(43) Pub. Date: Mar. 26, 2020

(54) CONTEXT-AWARE MOBILE DIGITAL ASSET DISTRIBUTION METHOD AND SYSTEM

(71) Applicant: ReCharge IT, LLC, North Charleston, SC (US)

(72) Inventor: Marvin Bissland, Daniel Island, SC (US)

(21) Appl. No.: 16/139,982

(22) Filed: Sep. 24, 2018

(51) Int. Cl. G06Q 30/02; G07F 15/00; G07F 17/12; H02J 7/00

(52) U.S. Cl. CPC G06Q 30/0237; G06Q 30/0271; H02J 7/0027; G07F 17/12; G07F 15/006

(57) ABSTRACT

A system and method for a context-aware digital assets distribution platform. The platform comprises means for distributing or broadcasting digital assets to mobile devices in conjunction with an object providing dynamic sources of context information. The digital assets distribution platform incorporates one or more component architecture, a mobile device application having one or modules for dynamic context sensing, context recognition, context and information communication-transmission, and digital assets content sharing via a mobile computing network. The platform enables the distribution or broadcast of personalized information or services to mobile device users.

### FIELD

The present disclosure relates to the field of context-aware mobile digital asset distribution systems; particularly, a management system and methods for capturing and processing contextual information and subsequent distribution of personalized digital assets.

### BACKGROUND

Mobile devices, with increasingly improved processing capabilities, have become smart personal computing and communication devices for billions of users worldwide. Smart mobile phones, personal digital assistants, and tablets incorporating advances in sensors, wireless communication, and information infrastructures, such as GPS and WIFI, have exposed the users to the massive amount of mobile services at anytime and anywhere. Smart phones with built-in sensors, notably cameras, microphones, and accelerometers, enable the detection of a user's situational contexts. The contextual information or data can be used to personalize the delivery of information and services to mobile users. Personalization means that the content or digital assets adapts to the user's environment, often useful for making recommendations and increasingly being exploited for advertising purposes.

Advertising can be defined as the act of presenting or describing a product, service, an offering, or an event in a public medium. Advertisements were designed traditionally for distribution to multiple consumers and created in a non-personal form, suitable for consumption by the masses. A major challenge among advertisers is to gain an individual's attention and to successfully deliver an advertisement message. The pervasiveness of mobile devices has provided advertisers with an intensely competitive media outlet to deliver their messages to consumers and a higher probability of success through personalization and enticement with rewards (e.g., coupons, etc.).

A context-aware recommendation system exploits contextual information obtained from mobile devices to learn the user preferences and subsequently provide information or services of interest. The type of contextual information used includes, for example, geo-location, activities, traffic information, environment situations, device characteristics, and network conditions. The relevant recommendations are provided according to the user preferences in those contextual situations. Recommender systems attempt to suggest items of potential interest to users (e.g., customers, tourists, etc.), where the items are used for denoting all the things that the systems recommend (e.g., products or services). Despite advances, built-in sensors (e.g., accelerometer) of smart devices produce low-level data, representing a major drawback. These low-level data, in their raw form, are not suitable for mobile applications because they don't often provide high-level contextual information. The use of pictures from a camera for contextual information requires relatively sophisticated image processing and data analytics. Therefore, obtaining context information from mobile devices alone may limit the ability to truly exploit the preferences of users in conjunction with their dynamic or changing contextual situations, environment conditions, or device characteristics. Often, the system cannot obtain context information when a mobile phone, powered by rechargeable batteries, has run out of energy. An alternative is to capture context information from other objects in the user's environments.

The need for charging of a mobile battery, anytime and anywhere, makes the energy source an ideal object for capturing context information of a user's consumption environment. Energy sources for recharging batteries are provided by a power supply available universally in homes, commercial facilities, airports, public buildings, or automobiles. Recharging stations or public kiosks have recently become available to accommodate the mobile device users, often at inopportune times, when batteries are running low. These stations and kiosks are usually secured lockers that enable users to register, pay, and charge a mobile device in a secured manner. Some kiosks offer the user the opportunity to charge a mobile device for free in exchange for personal information, taking a survey, and the like.

Interactive kiosks are becoming mainstream and are now located in entrances to stores, malls, and other public thoroughfares. They are deployed in public venues to support multiple functions such as: information provision, interaction between user and consumer to support the customization of information, transactions (e.g., ticket purchase), delivering advertising, relationship building through loyalty schemes, and in certain cases, recharging mobile device batteries. Therefore, charging kiosks represent another platform for vendors and advertisers to reach mobile device users by taking advantage of a captive event: a battery low state of charge. Thus, kiosks represent ideal locations and portals for retrieving or delivering context aware information via mobile devices. However, battery charging kiosks have not been considered as an object for providing contextual information of a mobile device based on the placement, direct physical connection to a power source, opening or secured closure within such locked units. Broadly, secured units (e.g., lockers, mail box, home delivery receptacles, etc.) in general have not been considered objects or portals for providing contextual information in combination with mobile devices.

Through applied effort, ingenuity, and innovation, Applicant has identified limitations and deficiencies in the ability to exploit the preferences of users in conjunction with the dynamics of their contextual situations and mobile device functionality, operation, or power conditions with existing context-aware digital assets distribution systems. Applicant has developed a solution that is embodied by the present invention, which is described in detail below.

### SUMMARY

The following presents a simplified summary of some embodiments of the invention to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

An object of the present disclosure is a system and methods for distributing digital assets to a mobile computing or communication device (as used herein, “mobile device”) in conjunction with an object providing dynamic sources of context information. In various embodiments, the object provides dynamic context information to a mobile device including but not limited to a mobile phone, a smart mobile phone, a personal digital assistant, tablet, game console, or the like. In various embodiments, the dynamic context information includes but is not limited to a(n): physical location (e.g., shop, building, street, city, etc.), environmental condition (e.g., weather, etc.), ambient condition (e.g., sound, illumination, etc.), a stationary or mobile device characteristic (e.g., power consumption level, battery life time, etc.), object-to-object interaction (e.g., mobile device connecting to a power source), human-to-object interaction (e.g., turning on or off a power button, opening or closing an enclosure), motion of an enclosure (e.g., opening/closing of a door, open/closing of an aperture, etc.), or the like. In various embodiments, the object may be a unit (e.g., station) that enables the recharging of a portable battery of a mobile device. In various embodiments, the object may be, but is not limited to a(n): power source, battery, smart battery, power socket, power plug, smart power supply battery charging station, battery charging kiosk, mailbox, smart mailbox, smart door, aperture, smart lock box, smart safe, smart locker, postal delivery receptacle, secured home delivery receptacle, package delivery hub, delivery lock, computerized letter box, or the like. One or more digital assets are delivered to a mobile device, including but not limited to a digital file type (e.g. PDF, PNG, JPG), a text, an image, a sound clip, an emoji, a GIF, a video, a motion picture, or the like. In various embodiments, the type of digital assets delivered is based on the contextual information of said objects and or preferences of a mobile device user.

An object of the present disclosure is a digital assets distribution platform comprising one or more component architecture. In various embodiments, one component is a physical layer comprising one or more objects providing one or more dynamic sources of context information. The one or more objects communicates with one or more mobile devices via direct connection (e.g., USB, Ethernet, etc.) or wireless using one or more wireless communication networks (e.g., Bluetooth, ZigBee, BLE, WIFI, cellular, 3G, 4G, 5G, etc.). In various embodiments, another component is a contextual information management layer stored and accessible on one or more application cloud servers. In various embodiments, one or more applications residing on a cloud server enables at least one entity (e.g., administrator, vendor, advertiser, etc.) to acquire, aggregate, process, or analyze, contextual data generated and received by one or more said objects. In various embodiments, one or more entities can process contextual data to complete or deliver a non-limiting service such as a(n) transaction, payment, text message, notification, voice message, coupon, offer, reward, loyalty point, remuneration, electronic currency, or the like, to a said mobile device. In various embodiments, one or more said services can be distributed by one or more mobile devices and shared among one or more mobile device users. In various embodiments, another component is a digital assets application layer that enables at least one entity to deliver personalized information or services to a mobile device, including but not limited to a(n) text message, sound clip, sound byte, image, picture, emoji, video, motion picture, or the like. The one or more objects communicates with one or more cloud servers via direct connection (e.g., USB, Ethernet, etc.) or wireless using one or more wireless communication networks (e.g., Bluetooth, ZigBee, BLE, WIFI, cellular, 3G, 4G, 5G, etc.). In various embodiments, the said object provides dynamic context information to at least one cloud server based on one or more said object-to-object (e.g., mobile device connection to an external power source), human-to-object interaction (e.g., opening or closing a door), a context recognized event derived from one or more sensors of said mobile device or object, or the like. In various embodiments, the said object provides dynamic context information including but not limited to its physical location (e.g., shop, building, street, city, etc.), environmental condition (e.g., weather, etc.), ambient condition (e.g., sound, illumination, etc.), functional status, power status, physical configuration, physical position or motion of one or more components of an object (e.g., door opening/closing), or the like.

An object of the present disclosure is a mobile device application comprising one or modules for dynamic context detection, context determination, context and information communication-transmission, and digital assets content sharing. In various embodiments, the dynamic context detection module collects and processes data from one or more sensors (e.g., accelerometer, microphone, light sensor, camera, GPS, etc.) of a mobile device, at one or more programmed time interval-durations, and transforms the information into contextual data for communication-transmission to said digital assets distribution platform. In various embodiments, the context determination module collects and processes data from one or more sensors (e.g., accelerometer, microphone, light sensor, camera, GPS, etc.) of a mobile device, at one or more programmed time interval-durations, and transforms the information into contextual data for communication-transmission to said digital assets distribution platform. In various embodiments, the context communication module collects the transformed information and sends the information to said digital assets distribution platform. In various embodiments, the context detection module collects and processes data from one or more objects providing dynamic sources of context information, at a transient or steady-state connection (direct or wireless) event, during one or more programmed time interval-durations, and transforms the information into contextual data for communication-transmission to said digital assets distribution platform. In various embodiments, a content sharing module receives one or more said digital assets from the said digital assets application layer and enables the distribution or broadcast of said assets to one or more mobile devices within a network, including but not limited an ad-hoc network.

Specific embodiments of the present disclosure include a digital asset distribution system comprising a smart locker apparatus having one or more receptacles, the one or more receptacles being selectively locked with an electronic locking mechanism, a controller configured to selectively engage the electronic locking mechanism in response to an authorized input, and a communications interface operably engaged with the controller to send and receive data via at least one wireless communications protocol; a smart phone executing a software application comprising instructions for displaying a location of the smart locker apparatus, receiving at least one digital asset in response to an authenticated user interaction with the smart locker apparatus, and displaying the at least one digital asset to a user; and, an application server operably engaged with the smart locker apparatus and the smart phone via a wireless communications network, the application server being operably engaged with the smart locker apparatus to authenticate a user interaction with the smart locker apparatus, and the application server being operably engaged with the smart phone to deliver the at least one digital asset to the software application in response to the authenticated user interaction with the smart locker apparatus.

Another specific embodiment of the present disclosure includes a method for context-specific distribution of a digital asset comprising establishing, with a smart phone executing a digital asset distribution software application, a user account associated with a user; locating, with the smart phone executing the digital asset distribution software application, a gateway apparatus; confirming, with an application server operably engaged with the smart phone via the digital asset distribution software, an instance of a specified user interaction with the gateway device; and, delivering, with the application server via a communications network, a digital asset to the smart phone or a predetermined email account in response to confirming the instance of the specified user interaction with the gateway device.

Yet another specific embodiment of the present disclosure includes a distributed digital asset distribution system comprising a plurality of kiosks defining a plurality of digital asset distribution gateways; a root user device executing a software application comprising instructions for displaying a location of at least one kiosk in the plurality of kiosks, receiving at least one digital asset in response to an instance of a user interaction with the least one kiosk in the plurality of kiosks, displaying the at least one digital asset to a root user, and sharing the at least one digital asset with a node user; a node user device executing the software application comprising instructions for displaying the location of at least one kiosk in the plurality of kiosks, receiving the at least one digital asset from the root user, and displaying the at least one digital asset to the node user; and, an application server operably engaged with the root user device and the node user device via a wireless communications network, the application server being operably engaged with the plurality of kiosks to verify the instance of the user interaction with the least one kiosk in the plurality of kiosks, and the application server delivering the at least one digital asset to the root user device in response to the instance of the user interaction with the least one kiosk in the plurality of kiosks.

The foregoing has outlined rather broadly the more pertinent and important features of the present invention so that the detailed description of the invention that follows may be better understood and so that the present contribution to the art can be more fully appreciated. Additional features of the invention will be described hereinafter which form the subject of the claims of the invention. It should be appreciated by those skilled in the art that the conception and the disclosed specific methods and structures may be readily utilized as a basis for modifying or designing other structures for carrying out the same purposes of the present invention. It should be realized by those skilled in the art that such equivalent structures do not depart from the spirit and scope of the invention as set forth in the appended claims.

### BRIEF DESCRIPTION OF DRAWINGS

The above and other objects, features and advantages of the present disclosure will be more apparent from the following detailed description taken in conjunction with the accompanying drawings, in which:

FIG. 1 is an illustration of a system for distributing digital assets via a mobile device in combination with a dynamic context information generating object, according to an embodiment;

FIG. 2 is an illustration of a digital asset distribution platform, according to an embodiment;

FIG. 3 is an illustration of a mobile device application, according to an embodiment;

FIG. 4 is a block diagram for a method executable by a mobile device that enables a user to receive one or more personalized digital assets, according to an embodiment;

FIG. 5 is a functional block diagram of a routine of a digital asset distribution system, according to an embodiment;

FIG. 6 is a functional block diagram of a routine of a digital asset distribution system, according to an embodiment;

FIG. 7 is a functional block diagram of a routine of a digital asset distribution system, according to an embodiment; and,

FIG. 8 is a block diagram of an example processing system capable of executing the example machine readable instructions of FIGS. 4-7.

### DETAILED DESCRIPTION

Exemplary embodiments are described herein to provide a detailed description of the present disclosure. Variations of these embodiments will be apparent to those of skill in the art. Moreover, certain terminology is used in the following description for convenience only and is not limiting. For example, the words “right,” “left,” “top,” “bottom,” “upper,” “lower,” “inner” and “outer” designate directions in the drawings to which reference is made. The word “a” is defined to mean “at least one.” The terminology includes the words above specifically mentioned, derivatives thereof, and words of similar import.

Embodiments of the present disclosure provide systems and methods for a context aware digital asset distribution platform. Embodiments of the present disclosure overcome limitations associated with prior art approaches and capabilities to retrieve and process dynamic content information from contextual objects for generating personalized recommendations and services to a mobile computing or communication device (hereinafter “mobile device”) for consumption by users. Embodiments include a system and methods for distributing digital assets to a mobile device in conjunction with an object providing dynamic sources of context information, a digital assets distribution platform comprising one or more component architecture, and a mobile device application comprising one or modules for dynamic context detection, context determination, context and information communication-transmission, and digital assets content sharing via a mobile device computing network.

According to various embodiments of the present disclosure, the limitations and deficiencies of prior art systems are solved with a system and methods for distributing digital assets via mobile devices in conjunction with an object providing dynamic sources of context information. The object may be, but is not limited to, a(n) power source, battery, smart battery, power socket, power plug, smart power supply battery charging station, battery charging kiosk, mailbox, smart mailbox, smart door, aperture, smart lock box, smart safe, smart locker, postal delivery receptacle, secured home delivery receptacle, postal delivery hub, package delivery hub, delivery lock box, computerized letter box, or the like.

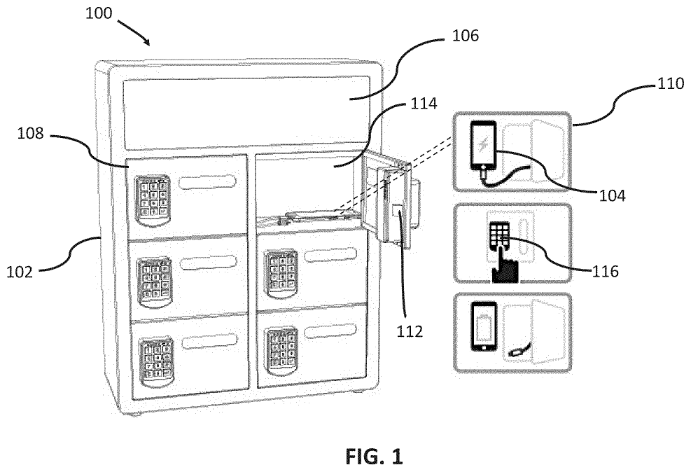

Referring now to FIG. 1, an illustration of a system 100 for distributing digital assets via a mobile device in combination with a dynamic context information generating object is shown. In a non-limiting example, a dynamic content generating object is a mobile device battery charging kiosk 102 that allows a mobile user to charge a mobile device 104. Kiosk 102 typically comprises a user interface or display 106 and one or more secured storage receptacles 108. Secured storage receptacles 108 may include a door 112 having an electronic locking mechanism being operable such that secured storage receptacles 108 may be selectively secured and accessed by actuating the electronic locking mechanism via an electronic controller. A battery backup system may be operably incorporated into kiosk 102 such that secured storage receptacles 108 may be selectively secured and accessed in the event of a power outage. A manual key override may also be incorporated into kiosk 102 to access secured storage receptacles 108 in the event of a total system failure.

A zoom illustration 110 further shows the details of each storage receptacle. Each storage receptacle has a door 112 that can be opened or closed providing access to an internal storage space 114 to enable a user to charge and store mobile device 104 within the object. Each door 112 is equipped with a security device 116 that requires a user to input a passcode required for device retrieval after the completion of the charging of mobile device 104 battery. Security device 116 may be incorporate one or more alternative means for access control, including but not limited to, biometric identification, facial recognition, low energy Bluetooth beacon, near field communication, and the like. Mobile device 104 may be a mobile phone, a smart mobile phone, a personal digital assistant, tablet, game console, or the like. Upon an event, such as a physical connection of mobile device 104 to a power source located within storage space 114, kiosk 102 and mobile device 104 communicate dynamic context information between the two units. The communication channel between said devices may include a direct connection via a USB connector for charging and data transfer, Bluetooth, BLE, WIFI, Ethernet, HDMI, optical transceiver, or the like. The context information may be sent, retrieved, or stored within a memory component of mobile device 104. The dynamic context information includes but is not limited to a(n): physical location (e.g., shop, building, street, city, etc.), environmental condition (e.g., weather, etc.), ambient condition (e.g., sound, illumination, etc.), physical condition, functioning, or characteristic (e.g., power consumption level, battery life time, etc.) of kiosk 102 and or mobile device 104, mobile device user information, and digital assets including but not limited to a(n) text, image, picture, emoji, sound clip, video, motion picture, voice message, coupon, offer, reward, loyalty point, electronic currency, remuneration, or the like, in current or future industry standards or formats. In a preferred embodiment, the type of digital assets delivered is based on the contextual information of an object and or preferences of a mobile device user. Other information exchange triggering events between the said object and mobile device may include but are not limited to a(n) object-to-object interaction (e.g., mobile device connecting to a power source), human-to-object interaction (e.g., opening or closing a door), motion of a component of an object (e.g., opening/closing of a door, open/closing of an aperture, etc.), or the like.

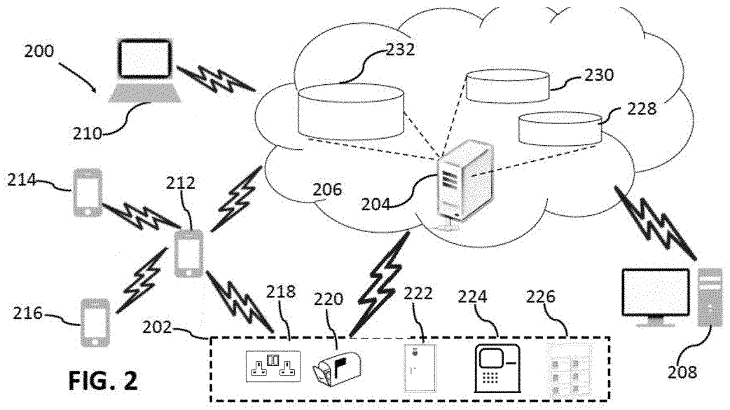

FIG. 2 shows an illustration 200 of a digital asset distribution platform according to various embodiments of the present invention. The platform 200 comprises: a physical layer 202; remote cloud server 204 of a contextual information management layer 206; a remote administration client 208; a remote vendor client 210; and one or more mobile devices 212, 214, 216. Physical layer 202 may comprise, depending on context, one or more objects capable of providing dynamic sources of context information. Non-limiting objects of physical layer 202 can include for example a(n): power source 218, mailbox 220, locker 222, package delivery hub 224, charging kiosk 226 equivalent to kiosk 102 of FIG. 1. These objects may incorporate one or more network communication means (e.g., USB, Ethernet, Bluetooth, ZigBee, BLE, WIFI, cellular, 3G, 4G, 5G, optical transceiver, etc.) enabling data communication between physical layer 202 and remote cloud server 204; similarly, between physical layer 202 and mobile device 212; further similarly between two or more mobile devices. The said object provides dynamic context information to at least one cloud server 204 based on an object-to-object (e.g., mobile device connection to an external power source), human-to-object interaction (e.g., opening or closing a door), a context recognized event derived from one or more sensors (e.g., accelerometer, microphone, optical sensor, facial recognition, biometric, near field communication, low energy Bluetooth beacon, etc.) of said mobile device 212, or the like, including but not limited to its physical location (e.g., shop, building, street, city, etc.), environmental condition (e.g., weather, etc.), ambient condition (e.g., sound, illumination, etc.), functional status, power status, physical configuration, physical position or motion of one or more components of an object (e.g., door opening/closing) of physical layer 202, or the like.

The contextual information management layer 206 comprises one or more cloud server 204. Each server provides access to a: context data acquisition application-database 228; context data management application 230; and a digital assets management application-database 232. Context data management application 230 may store information of one or more said objects of physical layer 202 including but not limited to type of object, function, serial number, physical location, components, data collected from database 228, or the like. Similarly, context data management application 230 may store information about mobile device 212 including but not limited to device type, function, characteristics, location, user preference, operation parameters, data collected from database 228, or the like. The one or more said applications residing on cloud server 204 enables an administrator, using remote administration client 208, or a vendor/advertiser using remote vendor client 210, to acquire, aggregate, process, or analyze, contextual data generated by one or more said objects of physical layer 202 or one or more mobile device 212, 214, 216. The administrator or vendor can process contextual data to complete or deliver a non-limiting offer or service such as a(n) transaction, payment, text message, notification, voice message, coupon, offer, reward, loyalty point, remuneration, electronic currency, or the like, to mobile device 212. In a non-limiting example, a vendor using client 210 can configure digital assets management application-database 232 to allow one or more said service to be shared between mobile device 212, 214, 216. The digital assets application-database 232 layer also enables a vendor to deliver personalized information or services to mobile device 212 including but not limited to a(n) text message, sound clip, sound byte, image, picture, emoji, video, motion picture, or the like. Mobile device 212 further distributes or broadcasts one or more said digital assets content to mobile device 214 and or mobile device 216 via a mobile device computing network including an ad-hoc mobile device wireless communication network.

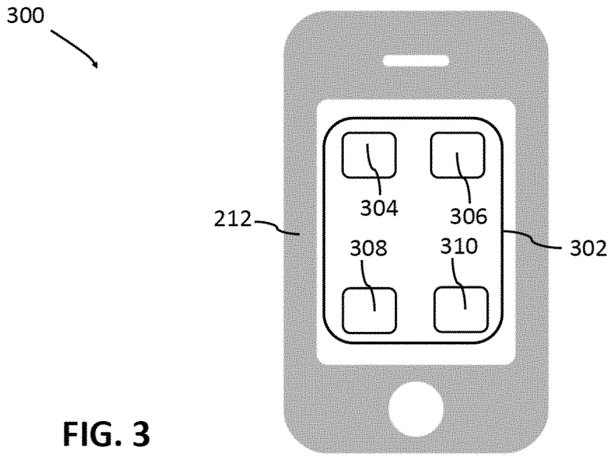

FIG. 3 shows an illustration 300 of a mobile device application according to various embodiments of the present invention. A user of mobile device 212 of FIG. 2 can access and download from the digital assets management application-database 232 an application 302 that enables a user to receive one or more personalized digital assets. Application 302 comprises a dynamic context detection module 304, a context determination module 306, context and information communication-transmission module 308, and digital assets content sharing module 310. Application 302 operates in conjunction with digital asset distribution platform 200 to enable the management and delivery of personalized information and services to a mobile device user.

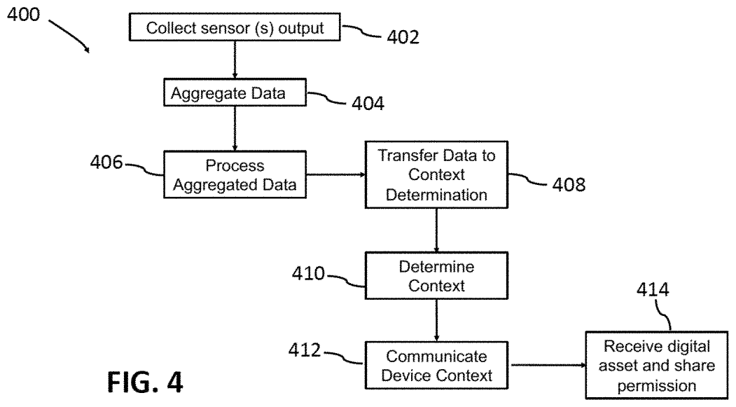

In accordance with various embodiments described herein, and with reference to FIG. 4, there is shown a block diagram 400 for a method executable by mobile device 212 via one or more combination of hardware, firmware, and software that enables a user to receive one or more personalized digital assets. In a non-limiting example, the dynamic context detection module 304 collects one or more sensor outputs at step 402, aggregates the data at step 404, and subsequently processes the aggregated data from one or sensors (e.g., USB, accelerometer, microphone, light sensor, camera, etc.) or geo-location system at step 406. At step 408, the data is then transferred to context determination module 306 for context determination. At step 410, context determination module 306 processes the transferred data to determine a physical location (e.g., shop, building, street, city, etc.), environmental condition (e.g., weather, etc.), ambient condition (e.g., sound, illumination, etc.), functional status, power status, physical configuration, physical position or motion of mobile device 212. In addition, module 306 may also process the transferred data to determine a physical location (e.g., shop, building, street, city, etc.), environmental condition (e.g., weather, etc.), ambient condition (e.g., sound, illumination, etc.), functional status, power status, physical configuration, physical position or motion of one or more components of an object (e.g., door opening/closing) of physical layer 202, or the like. At step 412, the device context is communicated to the digital asset platform using module 308. Once the context of mobile device 212 or one or more objects of physical layer 202 has been determined, a vendor or administrator, using client 208, 210, can configure digital assets management application-database 232 to send and for mobile device 212 to receive and share, using module 310, one or more said digital asset at step 414. In various embodiments, the mobile application 302 executes one or more steps 402 to steps 414 at one or more programmed time interval-durations, at a transient or steady-state connection (direct or wireless) event, during one or more programmed time interval-durations. In various embodiments, step 414 enables a mobile user to distribute said assets to one or more mobile device 214, 216, among others, within a network including but not limited to an ad-hoc network.

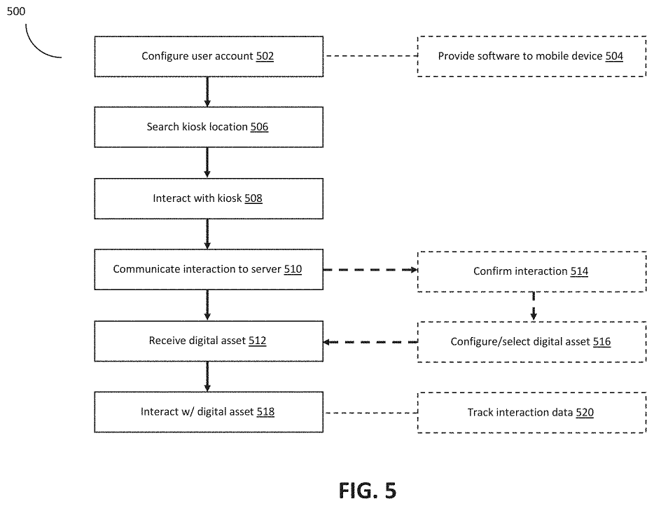

Referring now to FIG. 5, a functional block diagram of a routine 500 of a digital asset distribution system is shown. According to an embodiment, a routine 500 of a digital asset distribution system begins when a user configures a user account 502 via a web browser, mobile application, or other Internet enabled interface. In an embodiment, the user's account is configured and application software is provided and/or downloaded to the user's mobile device 504 (e.g. smart phone) via a remote application server being operably engaged with the user's mobile device via an Internet or cellular connection. The user accesses the application software via the mobile device to search for the location of one or more kiosks or asset distribution gateways 506, according to an embodiment. As described in FIG. 2, the one or more kiosks or asset distribution gateways may be configured as any number of physical objects, including a power source, battery, smart battery, power socket, power plug, Bluetooth beacon, smart power supply battery charging station, battery charging kiosk, mailbox, smart mailbox, smart door, aperture, smart lock box, smart safe, smart locker, postal delivery receptacle, secured home delivery receptacle, postal delivery hub, package delivery hub, delivery lock box, computerized letter box, or the like. The user views the location of the kiosk via the application software and proceeds to the location of the kiosk. Once in proximity of the kiosk, the user executes an interaction with the kiosk 508; for example, inputting an access code into an interface located on the kiosk or on the user's mobile device, inputting user account credentials into the kiosk, facial recognition or other means of biometric identification, and/or executing a near field communication protocol between the kiosk and the user's mobile device. The user interaction is communicated to the application server 510 via the user's mobile device or via a communications interface of the kiosk. The application server receives the communication and confirms the interaction 514 according to one or more rules. Upon communicating the interaction 510 and confirming the interaction 514, the application server configures or selects the digital asset 516, and communicates the digital asset to the user's mobile device or authorized email account. The user receives the digital asset 512 via the application software on the user's mobile device, and then interacts with the digital asset 518 via the application software on the user's mobile device. Examples of user interactions may include, but are not limited to, watching a video file, applying a coupon code or identification tag to a user transaction, downloading the digital asset, and sharing the digital asset. The application software may be configured to track and communicate data associated with the user's interaction with the digital asset 520. Tracking methods may include embedding metafiles or metadata within the digital asset, applying metadata tags or files to a transitory memory medium of the user's mobile device or computer, tracking of optical codes such as bar code and QR codes, and/or other commercially feasible methods of tracking the access and dissemination of digital files and/or assets.

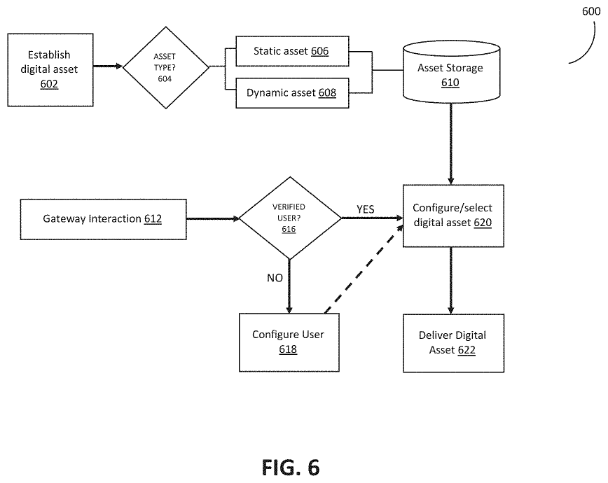

Referring now to FIG. 6, a functional block diagram of a routine 600 of a digital asset distribution system is shown. According to an embodiment, a digital asset is established 602 for distribution to a plurality of users over a digital asset distribution system. Digital assets may include digital coupons or other commercial offers, incentives, or advertisements. Routine 600 determines the asset type 604 as static assets 606 and/or dynamic assets 608. A static asset 606 may include specific files for distribution to users; for example, a video file of an advertisement. Dynamic asset 608 may include file frameworks with a plurality of file assembly rules. For example, a dynamic asset 608 may include a framework for generating a PDF file of a coupon. The assembly rules for generating the coupon may include rules such as the specifics of the coupon offer, the business(es) for which the coupon is valid, the coupon offer period, etc. Likewise, the assembly rules may be specific to user preferences or user characteristics, such as location. For example, the system may be configured to generate different assets for users in different geographic locations. Additionally, the system may be configured to generate different assets for users with different demographic characteristics; e.g. a 30 year old male user might receive a different asset than a 65 year old female user. Static assets 606 and/or dynamic assets 608 are stored in asset storage 610. A digital asset distribution workflow is triggered by an interaction with an asset gateway 612. The digital asset distribution system determines if the interaction with an asset gateway 612 was invoked by a verified user 616 (e.g. a user with an account). If the user is verified, the digital asset distribution system configures and/or selects a digital asset 620 and then delivers the digital asset to the user 622. If the user is not verified (e.g. does not have an account), the digital asset distribution system invokes a new user workflow to configure the new user 618. Upon configuring the user 618, the digital asset distribution system configures and/or selects a digital asset 620 and then delivers the digital asset to the user 622.

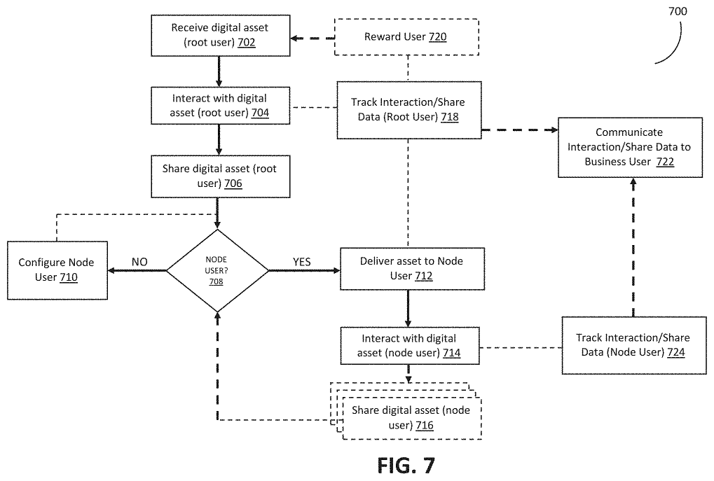

Referring now to FIG. 7, a functional block diagram of a routine 700 of a digital asset distribution system is shown. Routine 700 enables methods for tracking and sharing of digital assets between root users and node users of a digital asset distribution system. According to an embodiment, a root user receives a digital asset 702. The root user interacts with the digital asset 704, and data associated with the root user interaction is tracked 718 via an electronic device of the user and/or an application server. The root user shares the digital asset with a node user 706. The root user may share the digital asset with a specific node user (i.e. one to one) or the root user may share the asset over one or more third-party platforms or websites (e.g. social media). Routine 700 may further enable the root user to passively share the digital asset with one or more node users via a broadcast or push notification to one or more node users having a user association with the root user via the digital assent distribution system. The system verifies whether the node user is configured with a user account 708. If the node user does not have a user account, routine 700 invokes a new user workflow to configure the node user 710. If the node user does have a user account, routine 700 invokes a workflow to deliver the digital asset to the node user 712. The sharing relationship between the root user and the node user is tracked 718. The node user executes an interaction with the digital asset 714, and data associated with the node user interaction is tracked 724 via an electronic device of the node user and/or the application server. The node user may share the digital asset with a plurality of sub-node users (i.e. second level through n-level node users), in which case routine 700 invokes the workflows of user verification and asset tracking and asset tracking. Routine 700 tracks sharing data between the root user and the node user 718, as well as the sharing data between the node user and the sub-node users 724. The interaction and sharing data associated with the digital asset may be communicated to a business user 722. The interaction and sharing data communicated to the business user 722 may be utilized to generate an invoice or payment transaction. The interaction and sharing data associated with the digital asset may also be utilized to generate rewards, incentives or other remunerations 720 to the root user.

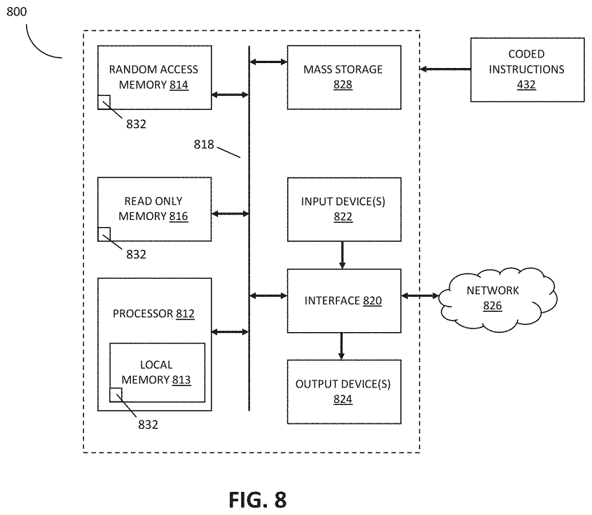

FIG. 8 is a block diagram of an example processor platform 800 capable of executing the instructions of FIGS. 4-7 to implement the example digital asset distribution system of FIGS. 1, 2, and/or 3. The processor platform 800 can be any suitable computing device such as, for example, a server, a computer, a system on chip (SoC) and/or application-specific integrated circuit. The processor platform 800 of the illustrated example includes a processor 812. The processor 812 of the illustrated example is hardware. For example, the processor 812 can be implemented by one or more integrated circuits, logic circuits, microprocessors or controllers from any desired family or manufacturer. The processor 812 of the illustrated example includes a local memory 813 (e.g., a cache). The processor 812 of the illustrated example is in communication with a main memory including a volatile memory 814 and a non-volatile memory 816 via a bus 818. The volatile memory 814 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 816 may be implemented by flash memory and/or any other desired type of memory device. Access to the main memory 814, 816 is controlled by a memory controller. The processor platform 800 of the illustrated example also includes an interface circuit 820. The interface circuit 820 may be implemented by any type of interface standard, such as an Ethernet interface, a universal serial bus (USB), and/or a PCI express interface.

In the illustrated example, one or more input devices 822 are connected to the interface circuit 820. The input device(s) 822 permit(s) a user to enter data and commands into the processor 812. The input device(s) can be implemented by, for example, an audio sensor, a microphone, and/or a button. One or more output devices 824 are also connected to the interface circuit 820 of the illustrated example. The output devices 824 can be implemented by, for example, a light emitting diode (LED). The interface circuit 820 of the illustrated example also includes a communication device such as a transmitter, a receiver, a transceiver, and/or network interface card to facilitate exchange of data with external machines (e.g., computing devices of any kind) via a network 826 (e.g., an Ethernet connection, a digital subscriber line (DSL), a telephone line, coaxial cable, a cellular telephone system, etc.). Coded instructions 832 corresponding to the machine readable instructions of FIGS. 4-7 may be stored in the volatile memory 814 and/or in the non-volatile memory 816 and/or a removable storage medium.

The present disclosure includes that contained in the appended claims as well as that of the foregoing description. Although this invention has been described in its exemplary forms with a certain degree of particularity, it is understood that the present disclosure of has been made only by way of example and numerous changes in the details of construction and combination and arrangement of parts may be employed without departing from the spirit and scope of the invention. The terms and expressions which have been employed in the foregoing description are used therein as terms of description and not of limitation, and there is no intention in the use of such terms and expressions to exclude equivalents of the features shown and described or portions thereof, it being recognized that the scope of the invention is defined and limited only by the claims which follow.

What is claimed is:

1. A digital asset distribution system comprising:
a smart locker apparatus having one or more receptacles, the one or more receptacles being selectively locked with an electronic locking mechanism, a controller configured to selectively engage the electronic locking mechanism in response to an authorized input, and a communications interface operably engaged with the controller to send and receive data via at least one wireless communications protocol;
a smart phone executing a software application comprising instructions for displaying a location of the smart locker apparatus, receiving at least one digital asset in response to an authenticated user interaction with the smart locker apparatus, and displaying the at least one digital asset to a user; and,
an application server operably engaged with the smart locker apparatus and the smart phone via a wireless communications network, the application server being operably engaged with the smart locker apparatus to authenticate a user interaction with the smart locker apparatus, and the application server being operably engaged with the smart phone to deliver the at least one digital asset to the software application in response to the authenticated user interaction with the smart locker apparatus.

2. The system of claim 1 wherein the software application executing on the smart phone further comprises instructions for sharing the at least one digital asset.

3. The system of claim 2 wherein the software application executing on the smart phone further comprises instructions for tracking the sharing of the at least one digital asset.

4. The system of claim 1 wherein the smart locker apparatus further comprises a digital input/output interface.

5. The system of claim 1 wherein the one or more receptacles of the smart locker apparatus further comprise a smart phone charging cable.

6. The system of claim 1 wherein the application server is configured to deliver the at least one digital asset to the software application according to one or more user parameters.

7. The system of claim 1 wherein the authenticated user interaction with the smart locker apparatus comprises accessing an interior compartment of a receptacle of the one or more receptacles.

8. The system of claim 4 wherein the authenticated user interaction with the smart locker apparatus comprises authenticating a user profile via the digital input/output interface.

9. A method for context-specific distribution of a digital asset comprising:
establishing, with a smart phone executing a digital asset distribution software application, a user account associated with a user;
locating, with the smart phone executing the digital asset distribution software application, a gateway apparatus;
confirming, with an application server operably engaged with the smart phone via the digital asset distribution software, an instance of a specified user interaction with the gateway apparatus; and,
delivering, with the application server via a communications network, a digital asset to the smart phone or a predetermined email account in response to confirming the instance of the specified user interaction with the gateway apparatus.

10. The method of claim 9 further comprising sharing, with the smart phone executing the digital asset distribution software application, the digital asset with a third-party smart phone or email account.

11. The method of claim 10 further comprising tracking, with the application server operably engaged with the smart phone via the digital asset distribution software, a plurality of sharing data associated with the sharing of the digital asset.

12. The method of claim 9 wherein the digital asset is a coupon.

13. The method of claim 9 further comprising configuring, with the application server, the digital asset according to a plurality of parameters associated with the user account.

14. The method of claim 9 further comprising tracking, with the digital asset distribution software, a user interaction with the digital asset.

15. The method of claim 14 further comprising reporting, with the application server via a communications network, the user interaction with the digital asset to a third-party device.

16. The method of claim 14 further comprising tracking, with the digital asset distribution software, historical data associated with user interactions with the gateway apparatus.

17. A distributed digital asset distribution system comprising:
a plurality of kiosks defining a plurality of digital asset distribution gateways;
a root user device executing a software application comprising instructions for displaying a location of at least one kiosk in the plurality of kiosks, receiving at least one digital asset in response to an instance of a user interaction with the least one kiosk in the plurality of kiosks, displaying the at least one digital asset to a root user, and sharing the at least one digital asset with a node user;
a node user device executing the software application comprising instructions for displaying the location of at least one kiosk in the plurality of kiosks, receiving the at least one digital asset from the root user, and displaying the at least one digital asset to the node user; and,
an application server operably engaged with the root user device and the node user device via a wireless communications network, the application server being operably engaged with the plurality of kiosks to verify the instance of the user interaction with the least one kiosk in the plurality of kiosks, and the application server delivering the at least one digital asset to the root user device in response to the instance of the user interaction with the least one kiosk in the plurality of kiosks.

18. The system of claim 17 wherein the digital asset is a coupon.

19. The system of claim 17 wherein the software application further comprises instructions for tracking a user interaction with the digital asset.

20. The system of claim 19 wherein the software application further comprises instructions for reporting the user interaction with the digital asset to the application server.
